(19) United States
(12) Patent Application Publication
(10) Pub. No.: US 2016/0143114 A1
(43) Pub. Date: May 19, 2016

(54) POWER SUPPLY DOUBLE SWITCH CONTROLLER

(71) Applicant: Kanghong Zhang, Santa Fe Springs, CA (US)

(72) Inventor: Kanghong Zhang, Santa Fe Springs, CA (US)

(21) Appl. No.: 14/591,686

(22) Filed: Jan. 7, 2015

Related U.S. Application Data
(60) Provisional application No. 62/080,577, filed on Nov. 17, 2014.

(51) Int. Cl. H05B 37/02

(52) U.S. Cl. CPC H05B 37/0209

(57) ABSTRACT

A power supply double switch controller has a ballast, a controller on the ballast having a first switch connector and a second switch connector. A first switch is connected to the first switch connector on the ballast. The first switch connector is a toggle switch with a first switch first position and a first switch second position. A second switch is connected to the second switch connector on the ballast. The second switch connector is a toggle switch with a second switch first position and a second switch second position. A mode dimming cycle is programmed on the controller. The controller is configured to receive a second switch first position and a second switch second position at a second switch connector, and a first switch first position and a first switch second position at the first switch connector.

The present invention is a nonprovisional of provisional patent application No. 62/080,577 filed Nov. 17, 2014 entitled Power Supply Double Switch Controller, by same inventor Richard Kanhong Zhang, the disclosure of which is incorporated herein by reference.

### FIELD OF THE INVENTION

The present invention is in the field of light controls, namely a power supply double switch controller.

### DISCUSSION OF RELATED ART

A variety of different configurations can be used for switching on and off and dimming a ballast for a fluorescent lamp or a driver for a light-emitting diode lamp. Traditionally, double switches have been used for controlling a lamp where the lamp has a first switch controlling a first ballast or driver and a second switch controlling a second ballast or driver. Activation of the first or second switch only can provide 50% lighting intensity.

### SUMMARY OF THE INVENTION

A power supply double switch controller has a ballast, a controller on the ballast having a first switch connector and a second switch connector. A first switch is connected to the first switch connector on the ballast. The first switch connector is a toggle switch with a first switch first position and a first switch second position. A second switch is connected to the second switch connector on the ballast. The second switch connector is a toggle switch with a second switch first position and a second switch second position. A mode dimming cycle is programmed on the controller. The controller is configured to receive a second switch first position and a second switch second position at a second switch connector, and a first switch first position and a first switch second position at the first switch connector. The first switch first position turns off the ballast and a first switch second position turns on the ballast. A change of the second switch first position to the second switch second position changes a mode of the dimming cycle to raise or lower a dimming level. The mode dimming cycle has at least three modes accessible by toggling the second switch. The ballast powering the lamp has a connection to a hot line and a neutral line. The hot line branches at a hot line junction into a first hot line having the first switch and a second hot line having the second switch. The second switch connector provides a selection control to set the dimming level. The controller is configured to adjust the dimming level by a user first turning on the lights with the first switch and then toggling the second switch until a desired dimming level is achieved. The controller changes dimming states when the second switch is changed from the on position to the off position. The controller can change dimming state when the second switch is switched to the on position from the off position, or the controller can change dimming state when the second switch is switched to the off position from the on position. The mode cycle can have at least a maximum mode, an intermediate mode, and a minimum mode. The maximum mode is set to 100% intensity. The intermediate mode is set below the maximum mode, and the minimum mode is set to 0% or 10%.

Also, the mode dimming cycle may have at least five modes, accessible by toggling the second switch. The mode cycle has a maximum mode, an intermediate mode, and a minimum mode. The maximum mode is set to 100% intensity. The intermediate mode is set between the maximum mode and the minimum mode. The minimum mode is set at a lowest level. A low mode is set to between the minimum and intermediate mode and a high mode set to between the maximum and intermediate mode.

The ballast powering the lamp has a connection to a hot line and a neutral line. The hot line branches at a hot line junction into a first hot line having the first switch and a second hot line having the second switch.

The controller changes dimming states when the second switch is changed from the on position to the off position, or the controller can change dimming state when the second switch is switched to the on position from the off position, or the controller can change dimming state when the second switch is switched to the off position from the on position. The second switch first position maintains a dimming level and the second switch second position automatically cycles through modes of the dimming cycle to raise or lower a dimming level after a predetermined amount of time as long as the second switch is in the second switch second position.

### BRIEF DESCRIPTION OF THE DRAWINGS

FIG. 1 is a diagram according to the prior art.

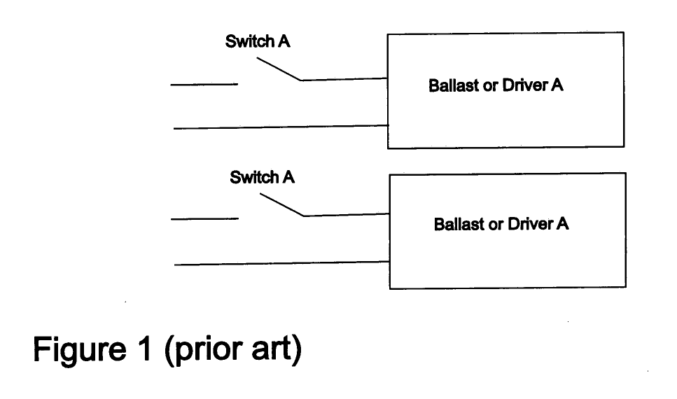

FIG. 2 is a diagram according to the present invention.

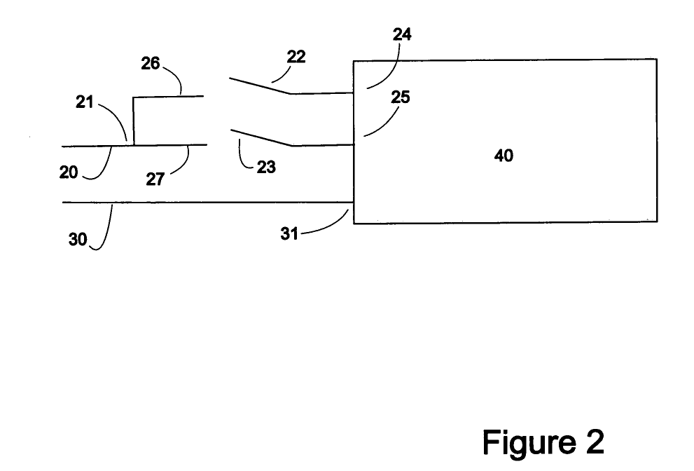

FIG. 3 is a diagram showing cycling of dimming capability.

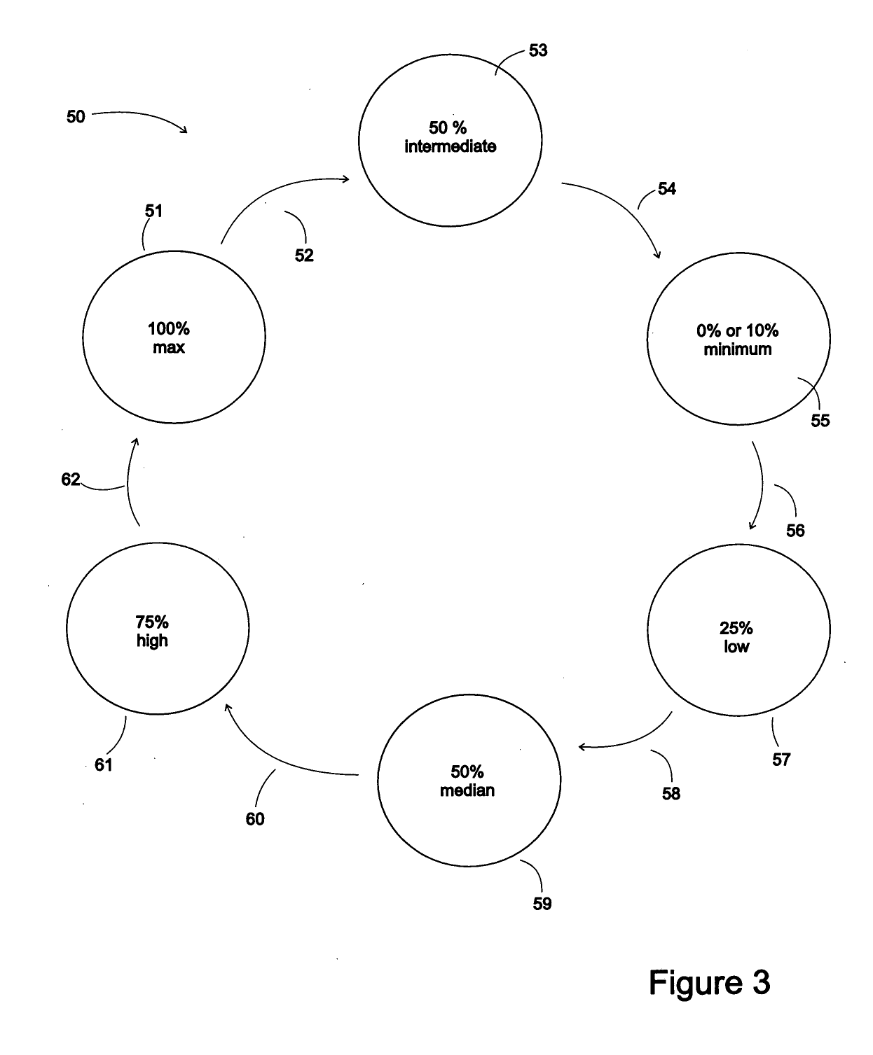

FIG. 4 is a diagram showing mode change possibilities.

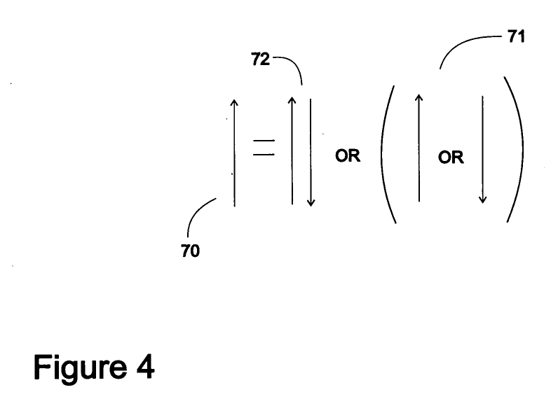

The following call out list of elements can be a useful guide in referencing the elements of the drawings.
20 Hot Line
21 Hot Line Junction
22 First Switch
23 Second Switch
24 First Switch Connector
25 Second Switch Connector
31 Neutral Line Connection
40 Ballast Or Driver Or Voltage Controller
50 Mode Cycle
51 Maximum Mode
52 Mode Change To Intermediate Mode
53 Intermediate Mode
54 Mode Change To Minimum Mode
55 Minimum Mode
56 Mode Change To Low Mode
57 Low Mode
58 Mode Change To Medium Mode
59 Medium Mode
60 Mode Change To High Mode
61 High Mode
62 Mode Change To Maximum Mode
70 Mode Change
71 Toggle
72 Double Toggle

### DETAILED DESCRIPTION OF THE PREFERRED EMBODIMENT

The present invention provides multiple levels of control to a florescent or LED lamp. A ballast powering a lamp has a connection to a hot line 20 and a neutral line 30. The hot line 20 branches at a hot line junction 21 into first hot line 26 having a first switch 22 and a second hot line 27 having a second switch 23. The first switch connector 24 connects to the first hot line 26 and receives an electrical input of current that is controlled by the first switch 22. The second switch connector 25 connects to the second hot line 27 and receives an electrical input of current that is controlled by the second switch 23.

The first switch 22 and the second switch 23 are on and off switches and not dimmers. The first switch 22 and the second switch 23 can be formed as toggle switches having a closed and open position. Toggle switches toggle between the closed and open position. Toggle switches can be wall mounted in electrical boxes and connected to a building electrical wiring.

The first switch connector provides a master on off switch control. When the first switch is in the on position, the ballast is connected to household electrical current and the ballast provides an output electrical current. When the first switch is in the off position, the ballast is completely turned off and isolated from the hot line. The first switch is used to turn off the lights by deactivating the ballast.

The second switch connector provides a selection control to set the dimming level. The second switch acts as a dimmer switch or dimming switch. A user adjusts the dimming level by first turning on the lights with the first switch and then toggling the second switch until a desired dimming level is achieved.

The second switch 23 being connected to the second switch connection 25, can operate a dimmer circuit located on the power supply which is the ballast or driver or voltage controller 40. The second switch connection 25 senses the change of state of the second switch 23. A controller connected to the second connection 25 in the ballast can change the dimming levels by adjusting the voltage and current when the controller reads one or more changes in state of the second switch 23. The controller can change dimming state when the second switch is changed from the on position to the off position, or the controller can change dimming state when the second switch is switched to the on position from the off position, or the controller can change dimming state when the second switch is switched to the off position from the on position.

The dimmer circuit has a mode cycle 50 of various dimming states. The second switch is connected to the second switch connector 25. The second switch connector 25 is connected to the dimmer circuit which is located on the ballast. The dimmer circuit is an example of a controller that can be implemented with a microcontroller, or with digital or analog circuitry.

The mode cycle 50 has at least a maximum mode 51, an intermediate mode 53, and a minimum mode 55. The maximum mode 51 can be preset to 100% intensity, and the intermediate mode can be set to 50%. The minimum mode can be preset to 0% or 10%. The luminosity percentages can be precalibrated to various lamps depending upon current control requirements.

The mode cycle 50 optionally includes a low mode 57, a medium mode 59 and a high mode 61. The low mode can be set to 25% intensity, the medium mode can be set to 50% intensity, and the high mode can be set to 75% intensity. The optional modes can be included on the mode cycle 50. Intensity can be varied by adjusting voltage, current or both voltage and current at the controller on the ballast.

Alternatively, the mode change to maximum mode 62 can be from the minimum mode 55 which would allow dimming from a maximum to an intermediate to a minimum and then back to the maximum again. The ballast may include multiple intermediate modes such as when the intermediate modes are a low mode, a medium mode and a high mode.

The second embodiment of the second switch still has two status positions, namely on and off. In the set and cycle configuration, the second switch also connects to the second switch connection 25, but the controller is configured differently so that one of the statuses can be set as cycle dimming and the other status as set. The off position can be the set position and the on position can be the cycle position. Alternatively, the on position can be the set position and the off position can be the cycle position.

When the user puts the switch to the dimming position, the output circle will cycle continuously until the desired dimming intensity is reached. The output cycle can cycle once per second, or at some other predefined time delay while in cycling position until the user flips the switch back to set position which stops cycling.

Implementation of the invention in a retrofit may require replacement of the ballast with a new ballast having a dimmer circuit attached or connected to the second switch connection of the power supply 40. The present invention eliminates the need for replacing pre-existing switch pairs and switch pair wires in buildings. Although a switch plate may be removed for inspection, the original toggle switch pair, switch pair electrical box and switch plate can remain as originally installed.

1. A power supply double switch controller comprising:
a) a ballast;
b) a controller on the ballast having a first and second switch connector;
c) a first switch, wherein the first switch is connected to the first and second switch connector on the ballast, wherein the first switch is installed on AC line voltage, wherein the first switch connector is a toggle switch with a first switch first position and a first switch second position;
d) a second switch, wherein the second switch is connected in series to the first switch wherein the second switch is installed on AC line voltage, wherein the second switch is a toggle switch with a second switch first position and a second switch second position;
e) a mode dimming cycle programmed on the controller, wherein the controller is configured to recognize a momentary power outage of between 0.1 and 0.6 second at the first and second switch connector when the second switch travels from a second switch first position to a second switch second position; wherein the controller also recognized a first switch first position and a first switch second position at the first and second switch connector, wherein the first switch first position turns off the ballast and the first switch second position turns on the ballast; wherein a momentary power outage changes a mode of the dimming cycle to raise or lower a dimming level.

2. The power supply double switch controller of claim 1, wherein the mode dimming cycle has at least three modes accessible by toggling the second switch.

3. The power supply double switch controller of claim 2, wherein the ballast powering the lamp has a connection to a hot line and a neutral line; wherein the hot line carries power that can be interrupted using the first switch for controlling power on and off, and the second switch for changing the dimming level.

4. The power supply double switch controller of claim 3, wherein the second switch connector provides a selection control to set the dimming level wherein the controller is configured to adjust the dimming level by a user first turning on the lights with the first switch and then toggling the second switch until a desired dimming level is achieved.

5. The power supply double switch controller of claim 4, wherein the controller changes dimming states when the second switch is changed from the on position to the off position, or the controller can change dimming state when the second switch is switched to the on position from the off position, or the controller can change dimming state when the second switch is switched to the off position from the on position.

6. The power supply double switch controller of claim 2, wherein the mode cycle has at least a maximum mode, an intermediate mode, and a minimum mode wherein the maximum mode is set to 100% intensity, wherein the intermediate mode is set below the maximum mode, and wherein the minimum mode is set to 0% or 10%.

7. The power supply double switch controller of claim 2, wherein the mode dimming cycle has at least five modes, accessible by toggling the second switch.

8. The power supply double switch controller of claim 7, wherein the mode cycle has a maximum mode, an intermediate mode, and a minimum mode wherein the maximum mode is set to 100% intensity, wherein the intermediate mode is set between the maximum mode and the minimum mode, and wherein the minimum mode is set at a lowest level, and further comprising a low mode is set to between the minimum and intermediate mode and a high mode set to between the maximum and intermediate mode.

9. The power supply double switch controller of claim 8, wherein the second switch has a bias, wherein the bias is mechanical.

10. The power supply double switch controller of claim 9, wherein the second switch connector provides a selection control to set the dimming level wherein the controller is configured to adjust the dimming level by a user first turning on the lights with the first switch and then toggling the second switch until a desired dimming level is achieved.

11. The power supply double switch controller of claim 10, wherein the controller changes dimming states when the second switch is changed from the on position to the off position, or the controller can change dimming state when the second switch is switched to the on position from the off position, or the controller can change dimming state when the second switch is switched to the off position from the on position.

12. The power supply double switch controller of claim 1, wherein the second switch first position maintains a dimming level and the second switch second position automatically cycles through modes of the dimming cycle to raise or lower a dimming level after a predetermined amount of time as long as the second switch is in the second switch second position.

13. The power supply double switch controller of claim 12, wherein the second switch connector provides a selection control to set the dimming level wherein the controller is configured to adjust the dimming level by a user first turning on the lights with the first switch and then toggling the second switch until a desired dimming level is achieved.

14. The power supply double switch controller of claim 13, wherein the controller changes dimming states when the second switch is changed from the on position to the off position, or the controller can change dimming state when the second switch is switched to the on position from the off position, or the controller can change dimming state when the second switch is switched to the off position from the on position.

15. The power supply double switch controller of claim 14, wherein the mode cycle has at least a maximum mode, an intermediate mode, and a minimum mode wherein the maximum mode is set to 100% intensity, wherein the intermediate mode is set below the maximum mode, and wherein the minimum mode is set to 0% or 10%.

16. The power supply double switch controller of claim 15, wherein the mode dimming cycle has at least five modes, accessible by toggling the second switch.

17. The power supply double switch controller of claim 16, wherein the mode cycle has a maximum mode, an intermediate mode, and a minimum mode wherein the maximum mode is set to 100% intensity, wherein the intermediate mode is set between the maximum mode and the minimum mode, and wherein the minimum mode is set at a lowest level, and further comprising a low mode is set to between the minimum and intermediate mode and a high mode set to between the maximum and intermediate mode.
